(19) United States
(12) Patent Application Publication
(10) Pub. No.: US 2007/0050116 A1
(43) Pub. Date: Mar. 1, 2007

(54) Yield monitor

(76) Inventor: William B. Jernigan, Wauchula, FL (US)

Correspondence Address: Connolly Bove Lodge & Hutz LLP, P.O. Box 2207, Wilmington, DE, 19899-2207, US

(21) Appl. No.: 11/489,141

(22) Filed: Jul. 19, 2006

Related U.S. Application Data
(60) Provisional application No. 60/701,573, filed on Jul. 22, 2005.

(51) Int. Cl. G06F 19/00; G01C 21/00

(52) U.S. Cl. 701/50; 701/213

(57) ABSTRACT

A yield monitor includes a harvesting device and yield data collection equipment including a GPS unit which collects sufficient data for determining the yield and global position of an agricultural commodity harvested by the harvesting device. A data recording device records the data in response to activation by a switch. The switch is automatically activated each time a batch of the commodity is collected without the use of human interaction at the time of data collection.

### CROSS REFERENCE TO RELATED APPLICATION

This application is based on provisional application Serial No. 60/701,573, filed Jul. 22, 2005.

### BACKGROUND OF THE INVENTION

It is common for growers of agricultural commodities to measure yield from their crops. In the past, it was only possible to collect yield data on a given field in its entirety. With the advent of precision agriculture, it has become important for growers to measure yield from crops more accurately.

The collection of yield data using GPS (Global Positioning Service) allows data to become spatially associated. Spatial data is data that has a specific address on the earth. Without GPS yield data crop yields were commonly averaged across an entire field. This is important because the process allows better management of a field by allowing micro management of the field, thus now being able to manage fields at a sub-field level.

The following companies manufacture yield monitors:

Yield monitors for grain crops (AgLeader, Micro-Trak Greenstar by John Deere, AFS by CaseIH);

Yield monitors for root crops (HarvestMaster);

Yield monitors for cotton (AgLeader, Zycom, Micro-Trak);

Precision yield monitoring is not a new concept to the agricultural industry. What has been done with yield monitoring has been most widely associated with the row crop market primarily corn, soybeans, wheat and rice. This process monitors the grain flow within the clean grain elevator located on the combine/harvester and it is constantly measured with the machine movement. Some lesser known models have used a sensor which measures the amount of light through the grain within this same clean grain elevator.

The root crop harvester measures the weight of the crop as it is dug from the soil and runs across cleaning rollers. This presents even larger inaccuracies do to the excess soil that is attached to the fruit/crop thus significantly effecting the true weight of the crop.

One type yield monitor is described in U.S. Pat. No. 6,525,276 (Vellidus, et.al.) Vellidus describes a unit that records collection of agricultural commodities in a weighing device, and then continual monitoring of the weight/yield. This data is collected along with input from a GPS unit. The data from the GPS unit is combined with operator input of the number of rows being harvested. From this data, yield is calculated and displayed on a per area basis.

Within the citrus market there is heretofore one known system marketed by a company called Geo Ag Solutions. The citrus monitor marketed by Geo Ag Solutions requires a manual log thus requiring human interaction each time the tub/bin is picked up and dumped in the field. The reason this is a problem is human interaction is not one hundred percent accurate because this step is often overlooked or forgotten during the event and it has been found that may times logging the bin pick up occurs at the wrong location when it is discovered that it has been forgotten to log. This further requires added tasks to be performed during the harvesting process which slows the harvester and often becomes an inconvenience to this operator.

It is known to provide a yield monitor which uses a harvesting device and yield data collection equipment including a GPS unit which is constantly collecting the information needed to determine yield. The information is recorded in a data recording device by an operator or other personnel entering the information through use, for example, of a key pad or touch screen. The need to rely upon human action to record the data leads to the possibility of error as previously discussed.

### SUMMARY OF THE INVENTION

An object of this invention is to provide a yield monitor wherein the information needed to determine the yield is automatically recorded without reliance on human interaction or input.

A further object of this invention is to provide such a yield monitor which utilizes a switch automatically actuated in response to some movement of a harvesting device associated with the collection of the agricultural commodity.

In accordance with this invention the yield monitor includes a harvesting device. Yield data collection equipment including a GPS unit is operatively mounted to the harvesting device for collecting sufficient data to determine the commodity yield and the global position of the commodity being collected in a given agricultural area. A switch is provided for activating the recording of the data in a data recording device. The switch is mounted on the harvesting device in such a manner that it is automatically activated each time a batch of commodity is collected. Such activation could be in response to a predetermined movement of a component of the harvesting device wherein the component movement is associated with the collection of the batch of commodity. As a result, the data is recorded without the use of human interaction at the time of data collection.

The invention may be practiced with various types of switches such as a hydraulic switch or a load cell or a laser and detector assembly. Other types of switches, such as light activated, sound activated or infra-red light activated switches could be used.

### BRIEF DESCRIPTION OF THE DRAWINGS.

FIG. 1 is a side elevational view of yield monitor utilizing a hydraulic switch in accordance with one embodiment of this invention;

FIG. 2 is a fragmental side elevational view of a portion of a yield monitor in accordance with this invention utilizing a load cell as the switch;

FIG. 3 is a view similar to FIG. 2 of a portion of a yield monitor in accordance with this invention utilizing a laser and detector assembly as the switch;

FIG. 4 illustrates a grid showing the yield of agricultural commodities in individual areas of a portion of an agricultural field through use of a GPS; and

FIG. 5 shows a grid of a larger agricultural area which includes the grid of FIG. 4 and also indicates a manner of depicting comparative yield of areas within the grid.

### DETAIL DESCRIPTION

In general, the present invention represents an improvement over prior art techniques. In particular, the present invention represents an improvement over techniques for determining a yield of agricultural commodities which utilizes a harvesting device and utilizes yield data collection equipment including a GPS unit for collecting sufficient data to determine the commodity yield and the global position in a given agricultural area. With such known yield monitors data is being constantly collected and is recorded in a data recording device by human interaction such as by the operation of a keypad or touch screen. Such equipment is known and available and a detailed description thereof is not necessary for an understanding of this invention. The invention departs from such prior art practices by eliminating the need for human interaction at the time of data collection. This is accomplished in general by including in the yield monitor a switch which is automatically actuated each time a batch of commodity is collected. The switch may be actuated by a predetermined movement of a component of the harvesting device which is associated with the collection of the batch of commodity. As a result, there is an automatic activation of the switch and a consequent recording of the data in the recording device while the agricultural commodity is being collected without requiring any action from a human.

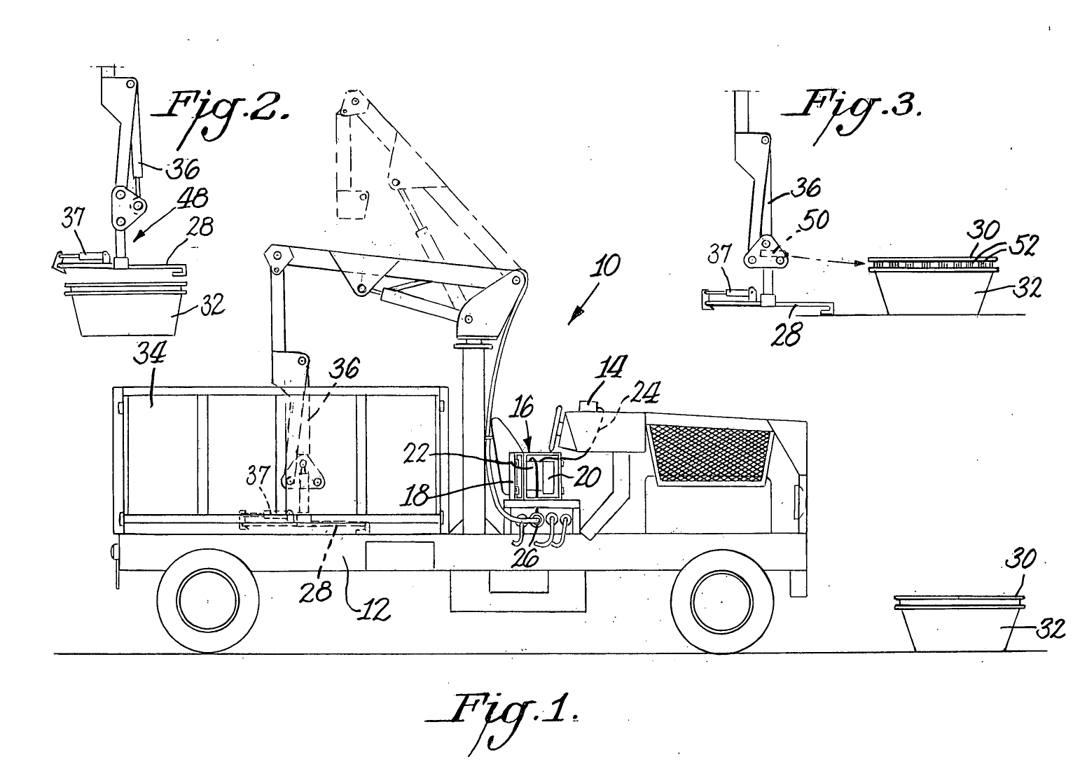

FIG. 1 illustrates a yield monitor 10 in accordance with one practice of this invention. As shown therein a typical harvest unit or “goat” which may be generally referred to as a harvesting device 12 is used for processing an agricultural commodity, such as fruit, in field-to-trailer transport.

Yield collection data equipment including a GPS unit 14 is mounted on any suitable location on the harvesting device 12. Similarly, as is known in the prior art a data logger unit or data collection device 16 is also mounted on the harvesting unit 12. FIG. 1 illustrates the data logger unit 16 with its door 18 in an open condition thereby showing the battery and power regulator 20 and the recording equipment 22 which could be a CR10X Data Logger. The information to be recorded in data recording device 16 is transmitted from the yield data collection equipment, including GPS 14 in any suitable manner, such as through a transmitter 24 schematically shown between GPS 14 and data recording device 16. The data is transmitted to data recording device 16 upon activation of a switch.

In the embodiment shown in FIG. 1 the switch 26 is physically located below data recording device 16 but could be in any other suitable location. Harvesting device 12 is of the type which includes a clamp head 28 of generally squared-off Y-shape that sits on top of the collection bin or tub 32 and clamps to the rim 30. Harvesting device 12 is of known construction and includes a collection body 34. The clamp head 28 is mounted to the end of a hydraulic cylinder 36, which is part of a known mechanism that would permit the clamp head 28 to be moved into contact and engagement with the tub 32. FIGS. 1-3, for example, illustrate the mechanism to include cylinder 37 which functions to clamp the clamp head 28 to the bin or tub 32. See in particular FIG. 2 which shows clamp head 28 directly above tub 32 prior to being moved to its clamping condition. The tub 32 would then be raised and its contents deposited into body 34. Cylinder 36 is used when the bin or tub 32 is located over the body 34 of the harvester and when activated will dump the tub by tilting the tub over the body 34. Activation of cylinder 36 will cause the hydraulic switch 26 to trigger the data logger.

As previously pointed out, in the embodiment of FIG. 1 when hydraulic cylinder 36 dumps the bin or tub 32 into body 34 the hydraulic switch 26 is actuated. Any suitable manner of actuation may be used, since the manner of actuation is not critical to the invention. What is important is that the actuation is correlated to the act of collecting the commodity. Upon actuation of switch 26 the data being collected from the data collection equipment, including GPS unit 14, is automatically recorded in the data logger 22 of data recording device 16. As a result, each time a batch of commodity is collected such as by the dumping of the agricultural commodity from tub 32 into body 34 the data necessary to determine the yield is recorded in data recording device 16. This recording results automatically by actuating the hydraulic switch 26 in response to a predetermined movement of a component, in this case, the hydraulic cylinder 36 of the harvesting device 12 wherein the movement of that component 36 is associated with the collection of the batch of commodity from tub 32. This recording of data automatically occurs without requiring human interaction at the time of data collection. The activation of the switch 26 would result in the same recording of data in the data recording device as is now done by human input.

The actuation of hydraulic switch 26 can be done in any suitable manner given the teachings of this invention. In the embodiment described in FIG. 1 the actuation occurs when the hydraulic cylinder dumps the agricultural commodity from tub 32.

Any desired data can be collected and recorded in accordance with this invention to provide a yield monitor for the agricultural commodities being collected. Preferably, the data should include the latitude and longitude (i.e., specific location), the time of collection and some indication of amount, such as weight or quantity of the commodity being collected. In addition, such data also preferably includes the date of collection. Other data might include information sufficient for determining payroll. In that regard, workers might be paid in some direct correlation to the amount of crop or agricultural yield collected by that worker. Further data includes, for example, the battery condition of power regulator 20 in the yield monitor.

The present invention permits the provision of a system to monitor crop yields within test plots to measure yield differences. The yield monitor 10 described here marks the point that the crop was picked up in the field. This is done automatically during the dumping procedure into the body 34 of the harvester 12. What is most significant about this yield monitor 10 is that the data is recorded or logged automatically and requires no interaction by the harvesting operator.

The data collected by this invention allows the creation of a map which allows the producer to visualize what actually occurred in the field. With the data collected from this yield monitor, the user can consult with the producer on ways to improve the crop management practices by managing the crop at a sub-field level. Growers can then improve the use of crop inputs such as pesticides and nutrients better tailored to the field/crop needs.

The invention differs from the prior art described by Vellidus (U.S. Pat. No. 6,525,276) in that the data collected by this invention uses an automatically actuated switch to collect data at a precise location. The harvesting apparatus in this invention is not significantly moving at the time of the agricultural commodity being loaded into the weighing apparatus. Furthermore, the present invention does not require any operator input. The Vellidus patent describes user input of the number of rows being harvested.

The yield monitor 10 includes an enclosed box containing a logging device 16 with a GPS receiver placed on the hood of the harvester. Examples of suitable equipment for the yield monitor are:

Data Logger 22=Campbell Scientific CR10X;

Power Supply 20=Campbell Scientific Power Regulator and a 12 volt closed cell Battery;

GPS 14=Garmin; and

Hydraulic Pressure Switch 26.

FIGS. 4-5 show the results of collecting data through use of the yield monitor 10. FIG. 4 illustrates a ¼ acre grid 38 subdivided into smaller areas 40,40. The yield monitor would determine the exact amounts and locations of the agricultural commodity being collected in the subdivided areas 40 within the grid 38 including the specific number and location of the tubs within each area 40. The information could then be used to create a density grid for showing the relative amount of yield within each area 40 as compared to other areas 40. An example of the types of density yield that could be depicted in the grid is shown in the chart associated with FIG. 5.

FIG. 5 illustrates how the grid 38 could be incorporated in a larger grid which would include other grids 42,44 and 46 along with grid 38 to show an entire agricultural area or field. This results in the creation of a yield map for the agricultural field. The information could then be used to control any type of variable rate applicator controller.

FIG. 1 illustrates a practice of the invention wherein the switch is automatically activated in response to some type of movement of a component of the harvesting device associated with the collection of the batch of commodity being harvested. Specifically, FIG. 1 illustrates the practice of the invention wherein the switch is a hydraulic switch 26. It is to be understood, however, that the concepts of this invention may be practiced with other types of switches which are automatically activated in response to a batch of commodity being collected. FIG. 2, for example, illustrates the use of a load cell 48 mounted to harvesting device 12 in the general area as the hydraulic cylinder 36. A suitable location for the load cell could also be in the arm that picks up the container. Such structure could include a scale for weighing the container and its contents. Such load cells are known in the art. Examples of suitable load cells are described in Vellidis U.S. Pat. No. 6,525,276 and Dojan U.S. Pat. No. 5,636,680. All of the details of those patents are incorporated herein by reference thereto for all purposes with regard to the practice of this invention. In the Vellidis patent the load cell is used to determine the weight of the crop (peanuts) being collected. With the present invention, while the load cell 48 could be used for determining the actual weight of commodity being collected, the basic use of the load cell is to act as an on/off switch which is actuated (on) in order to record the data in the recording device 16. In that regard, the weight of an empty tub 32, for example, would be known and a predetermined weight which is equal to the weight of the empty tub 32 or slightly greater than the weight of the empty tub could be used as the activation weight whereby when that weight is reached the load cell 48 is activated and causes the data transmitted from the yield data collection equipment to be recorded in the recording device. In this practice of the invention the switch activation is related to the weight determination of the commodity being collected, rather than to movement of a component of the harvesting device as would be the case with the hydraulic switch 26 being actuated when hydraulic cylinder dumps the contents from tub 32. It is understood, of course, that when the embodiment of FIG. 2 is utilized for practicing the invention, there would be movement of components of the harvesting device in order to pick up the bin or tub so that the weight could be sensed by load cell 48.

The utilization of a load cell also provides advantages of measuring the weight which would allow for more accurate logging information including the weight data. This enhancement by measuring weight would allow expansion into various fruit markets.

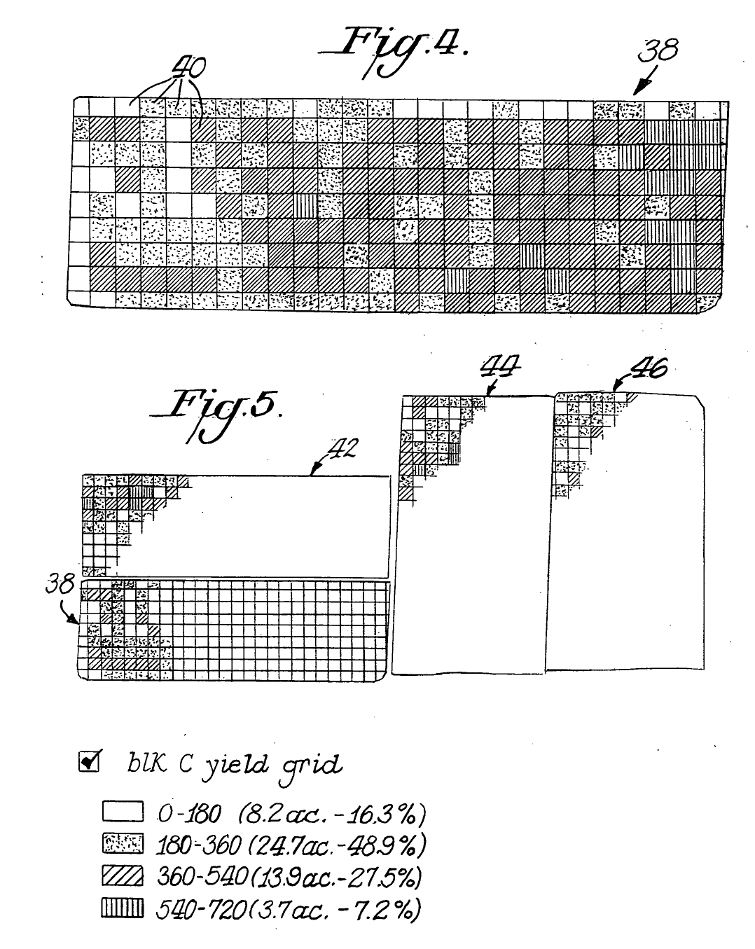

FIG. 3 illustrates a further practice of this invention wherein a laser 50 is provided at any suitable location on the harvesting device, such as in the general area of the hydraulic cylinder 36 and clamp head 28. The laser 50 could be used in association with a detector to sense when a tub 32 is being collected by harvesting unit 12. This could be accomplished in any suitable manner. FIG. 3, for example, illustrates a bar code 52 around tub 32 in the general area of rim 30. As the clamp head 28 moves to a position for engaging and lifting tub 32 the laser 50 senses the bar code 52 to activate a switch thereby causing the data from the yield collection equipment to be recorded in the recording device 16.

The present invention could be practiced to provide a yield monitor used not only in the citrus market but also could be easily adapted to the fresh fruit market (i.e. citrus, stone fruits, apples, grapes, avocados, tropical tree crops including any crop that is harvested and is being placed into a container that is picked up mechanically). These other applications or segments will require a switching mechanism because no dumping of the crop occurs from the picked up bin/tub into the body of the harvesting unit. These markets must reduce crop handling and the actual tub/bin is loaded onto the body of the harvester and carried to the processing facility within this same bin/tub that it is harvested directly into while in the field.

It is to be understood that the invention could be practiced with other types of switches than those specifically described. Examples which are not limiting examples include various light switches, such as infra-red, various sound switches, such as ultrasonic, and magnetic switches. In addition, the switch activation could be used through the use of a smart chip.

The invention could thus be practiced where the switch is pressure activated, light activated or weight activated. Where the invention is practiced using weight activation the harvesting device might also include a weighing scale to weigh the agricultural commodity.

The following is an example of the use of yield monitor 10 in the embodiment shown in FIG. 1. When a tub 32 is engaged by clamp head 28 and is raised over the body 34 of harvesting device 12 the hydraulic switch is actuated by hydraulic cylinder 36 when the contents of tub 32 are being dumped into body 34. Upon actuation of switch 26 the data from GPS 14 would be transmitted to and recorded by data recording device 16. This data would indicate by latitude and longitude the precise location of the container or tub 32. In addition, the GPS data would include the day and time. Such location information would be correlated to the appropriate area 40 on grid 38 so that the density of the yield in that area could be determined. In addition, the quantity of the yield would be in terms of the number of tubs 32 collected from an individual area. Such information could also be used for determining payroll where the workers in that area are paid in accordance with the number of tubs filled by each worker. Where the crop being harvested is such that the yield is in terms of weight, rather than volume, a reading from a scale, particularly where the switch is a load cell could be used to input the data correlating to the weight. Other information collected by the yield data collection equipment could also be recorded in the recording device.

Although the invention has been described with regard to, for example, the fresh fruit market the concepts of the invention could be used for monitoring the yield of any agricultural product. Preferably the product is collected in batches, such as in individual containers or tubs/bins. The invention, however, could be practiced where the collection is of a continuous nature and the switch activation automatically takes place after a predetermined time or predetermined distance of travel of harvesting device 12. In that sense the continuous collection over a period of time or distance might be considered as a batch. What is intended is that the “batch” collection should be one which is related to a specific location in an agricultural field so that the yield in the field can be effectively monitored.

All the references described above are incorporated by reference in their entirety for all useful purposes.

While there is shown and described certain specific structures embodying the invention, it will be manifest to those of ordinary skill in the art that various modifications and rearrangements of the parts may be made without departing from the spirit and scope of the underlying inventive concept and that the same is not limited to the particular forms herein shown and described.

1. A yield monitor for agricultural commodities comprising a harvesting device, yield data collection equipment including a GPS unit operatively mounted to said harvesting device for collecting sufficient data for determining the commodity yield and the global position in a given agricultural area, a data recording device for recording the data from said yield data collection equipment, a switch for activating the recording of the data in said recording device, said and switch being mounted on said harvesting device in such a manner as to be automatically activated each time a batch of commodity is collected without the use of human interaction at the time of data collection.

2. The monitor of claim 1 wherein said switch is activated in response to a predetermined movement of a component of said harvesting device, and said movement of said component being associated with the collection of a batch of commodity.

3. The monitor of claim 1 wherein said switch is activated when a predetermined weight is sensed upon the lifting of a container holding the batch of commodity.

4. The monitor of claim 1 wherein said switch is a hydraulic switch.

5. The monitor of claim 1 wherein said switch is a load cell.

6. The monitor of claim 1 wherein said switch includes a laser.

7. The monitor of claim 1 wherein said switch is pressure activated.

8. The monitor of claim 1 wherein said switch is activated by resistance.

9. The monitor of claim 1 wherein said switch is light-activated.

10. The monitor of claim 9 wherein said switch is an infra-red switch.

11. A method of determining the yield of an agricultural area including the steps of providing a harvesting device for collecting batches of an agricultural commodity providing yield data collection equipment including a GPS unit for collecting sufficient data to determine the commodity yield and the global position in a given agricultural area, providing a data recording device for recording the data from the yield collection equipment, and activating the recording of the data in the recording device through the activation of a switch which is automatically activated each time a batch of commodity is collected without the use of human interaction at the time of data collection.

12. The method of claim 11 wherein the switch is activated in response to a predetermined movement of a component of a harvesting device which is associated with the collection of the batch of commodity.

13. The method of claim 12 wherein the component is a hydraulic cylinder and the switch is a hydraulic switch which is activated when the hydraulic cylinder causes the commodity to be dumped from a collection tub.

14. The method of claim 11 wherein the switch is activated when a predetermined weight correlated to the weight of a commodity collection tub is reached.

15. The method of claim 14 wherein the switch is a load cell and the weight of the commodity being collected is also determined.

16. The method of claim 11 wherein the switch is activated in response to pressure.

17. The method of claim 11 wherein the switch is light-activated.

18. The method of claim 11 wherein the agricultural commodity is citrus.

19. The method of claim 11 wherein the agricultural commodity is selected from the group consisting of stone fruits, apples, grapes, avocados and tropical tree crops including any crop harvested and placed into the harvesting device while remaining in its collection container.

20. The method of claim 11 including placing the agricultural commodity into a container in the field, and then mechanically picking up the container and removing the container.

21. The method of claim 11 wherein the data collected is used to compute payroll information.

22. The method of claim 11 wherein the data is used to create a map of the agricultural area divided into individual areas depicting the yield in each individual area.
